(19) United States
(12) Patent Application Publication
(10) Pub. No.: US 2010/0108559 A1
(43) Pub. Date: May 6, 2010

(54) PACKAGED PRODUCT COMBINATION

(76) Inventor: Edwin Kohl, Perl (DE)

Correspondence Address: MARGER JOHNSON & MCCOLLOM, P.C., 210 SW MORRISON STREET, SUITE 400, PORTLAND, OR, 97204, US

(21) Appl. No.: 12/524,627

(22) PCT Filed: Jan. 28, 2008
(86) PCT No.: PCT/EP2008/050953

§ 371 Date: Jul. 27, 2009

(30) Foreign Application Priority Data
Feb. 8, 2007 (EP) 07101975.6

(51) Int. Cl. A61J 7/04; B65D 83/04; B65D 85/00; B65B 1/00; A61J 1/03

(52) U.S. Cl. 206/531; 206/534; 53/396

(57) ABSTRACT

A packaged product combination comprises a number of different medicaments of different shape and/or colour, the actual shape and/or colour of the medicaments providing user information relating to the medicament, for example a recommended dosage time in relation to meal times. For example, products to be taken before meal times can be elongate, products to be taken at meal times can be circular, and products to be taken after meal times can be triangular. In this way, the invention helps patients take the medication correctly, such that patients will longer be able to self-medicate and will not be reliant on inpatient care.

### FIELD OF THE INVENTION

The invention relates to a packaged product combination comprising a number of different medicaments or the like, and also to an appertaining method of making up and packaging a product combination of this kind.

### RELATED PRIOR ART

A blister pack for the weekly medicament requirements of a patient who is supposed to take the medicaments in a sequence arranged according to date, day of the week and time of day (morning, midday, evening and, if applicable, night) is known from WO 2005/102862 A1. The receiving compartments of the blister pack for receiving the particular medicaments are arranged in the form of a matrix and have seven “day” lines with at least three “time of day” compartments in each case, which are sealed, as a whole, by a continuous blister film. Located on the blister pack is a cover in the form of cardboard, which contains, in a manner relating to the individual patient, the composition of the individual “time of day” compartments and also prescription information relating to the particular medicaments.

For patients who regularly have to take a number of different medicaments, packaging units of this kind constitute an aid to, on the one hand, not forgetting to take important medicaments and, on the other hand, also reliably keeping track of which medicaments have already been taken, in order to avoid over-medication which may, under certain circumstances, be harmful. The “week” blister pack described in WO 2005/102862 A1 thus reliably aids medication of the patients that meets the requirements, and at the same time said pack can be manufactured cost-effectively and provisioned individually for a large number of patients by means of a provisioning machine.

The “time of day” compartments of the “week” blister pack described in WO 2005/102862 A1 indicate to the patient simply and clearly at what time of day a medicament is to be taken. For the effectiveness of many medicaments, however, it is important whether the preparation is taken before, during or after a meal. In the “week” blister pack known from WO 2005/102862 A1, this additional information regarding use is communicated to the patient by means of instructions for use printed on a cover section of said blister pack. Because of the large number of necessary details, however, these written instructions for use may possibly be difficult to read, particularly for elderly and particularly visually impaired patients, because of the size of the lettering, which is limited for reasons of space.

### SUMMARY OF THE INVENTION

It is therefore an object of the invention to propose a packaged product combination comprising a number of different medicaments or the like, and also an appertaining method of making up and packaging a product combination of this kind which supplies the patient with additional information regarding the use of the particular medicament without said patient having to read written instructions.

The object is achieved by means of a packaged product combination comprising a number of different medicaments of different shape and/or colour, wherein the shape and/or colour of the medicaments themselves give(s) information regarding the use of the medicament, for example a recommended ingestion time with reference to a meal. For example, preparations to be taken before a meal may be elongate, medicaments to be taken during the meal may be circular, and ones to be taken after the meal may be triangular in shape. If the time of use with reference to a meal is immaterial, a spherical shape, for example, may be provided.

Alternatively, the ingestion time with reference to a meal may also be coded by means of a colour, e.g. yellow before the meal, green during it, blue afterwards and red if the ingestion time is immaterial. Naturally, however, shape coding is more suitable for visually impaired patients.

The blister pack may be provided with a number of receiving compartments, which are sealed by a film in each case, for receiving a number of the medicaments, which receiving compartments are each assigned to a specific time of use (morning, midday, evening and, if applicable, night) within the prescribed period of use. This being the case, the receiving compartments of the blister pack may be arranged in the form of a matrix with a number of lines for days of use and columns for times of use during the day (morning, midday, evening and, if applicable, night). The blister pack may preferably be designed as a “week” blister pack for a week's requirements.

The blister pack may have sections with perforations which allow the severing of individual (“day”) lines of the matrix-shaped blister pack.

In particular, the product combination may be designed as a personalised product combination comprising an individually prescribed combination of medicaments for a specific person for a prescribed period.

The products concerned may be medicaments, vitamin preparations, dietary supplements, etc.

The invention also proposes a method of making up and packaging a product combination consisting of a number of different medicaments or the like, wherein the shape and/or colour of the medicaments themselves is/are so designed that it/they indicate(s) a piece of information regarding the use of the particular medicament.

### BRIEF DESCRIPTION OF THE DRAWINGS

The invention will be described in detail below with the aid of exemplified embodiments and with reference to the drawings.

FIG. 1 shows a diagrammatic perspective view of a “week” blister pack according to one exemplified embodiment of the invention;

FIG. 2 shows a cross-sectional view of the “week” blister pack from FIG. 1; and

FIG. 3 shows, by way of an example, various possible shapes for medicaments, in side or perspective view and in plan view.

### DETAILED DESCRIPTION OF THE INVENTION

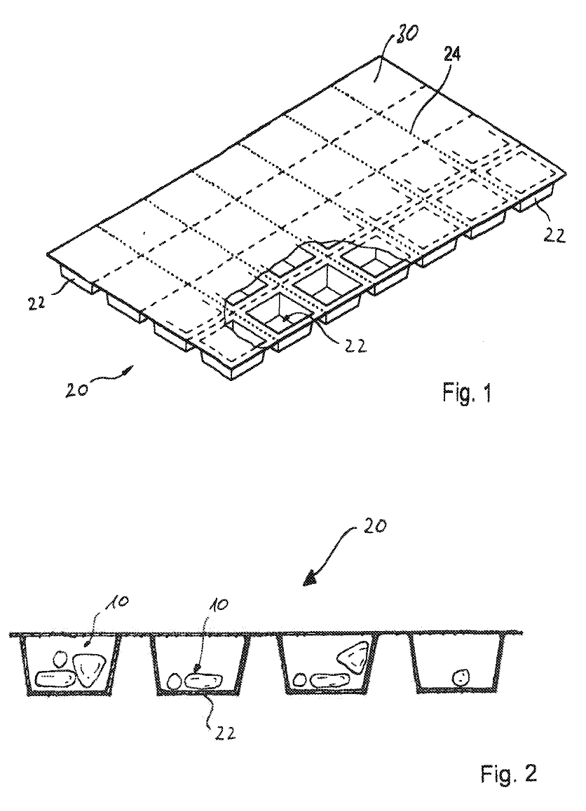

FIG. 1 shows an exemplified embodiment of a personalised blister pack 20 according to the invention. Said pack is designed as a so-called “week” blister pack for supplying a person or patient with medicaments and similar products such as, say, vitamin preparations, dietary supplements, etc. for a period of one week. Naturally, the invention is not limited to a specific period. In the blister pack 20, which is in the general form of a matrix, there is provided, for each day of the week, a line, which can be severed by means of a perforation 24, of receiving compartments 22, of which there are four in the example shown and which each contain the products which are to be used “early” (“morning”), “midday”, “evening” or “night”, or “at breakfast-time”, “at lunch-time”, “at dinner-time” and “before going to bed”. It is also possible to provide a different number of receiving compartments 22, depending upon the field of application.

The receiving compartments 22—of which there are 28 in all in the exemplified embodiment shown in FIG. 1—are inexpensively manufactured on a mass-produced basis by deep-drawing from a, preferably transparent, thermoplastic material, and have sufficient space for a plurality of tablets, capsules, coated pills, etc. in each case. All the receiving compartments 22 may be sealed by a common film 30, or a thin aluminium foil, and be provided with symbols for the ingestion time (morning, midday, evening, night). Furthermore, a cover (not represented), which is formed onto the blister pack 20, preferably in a foldable manner, may be provided for covering the film 30, with lettering faces for printing on detailed information regarding use.

The patient is able to easily remove the products to be taken at the particular time of day, by tearing-open the thin film. As a result of the perforation 24 of both the plastic blank forming the receiving compartments 22 and the film 30, “day” strips can be severed from the blister pack 20 so that patients can conveniently take said “day” strips with them.

FIG. 2 shows, in a cross-sectional view, the “week” blister pack 20 illustrated in FIG. 1. The four receiving compartments 22 for morning, midday, evening and night can be clearly seen; and so, too, can the products 10 located therein. These have different shapes (elongate, spherical, cylindrical or triangular), which each communicate a condition of use, for example the ingestion time with reference to a meal time.

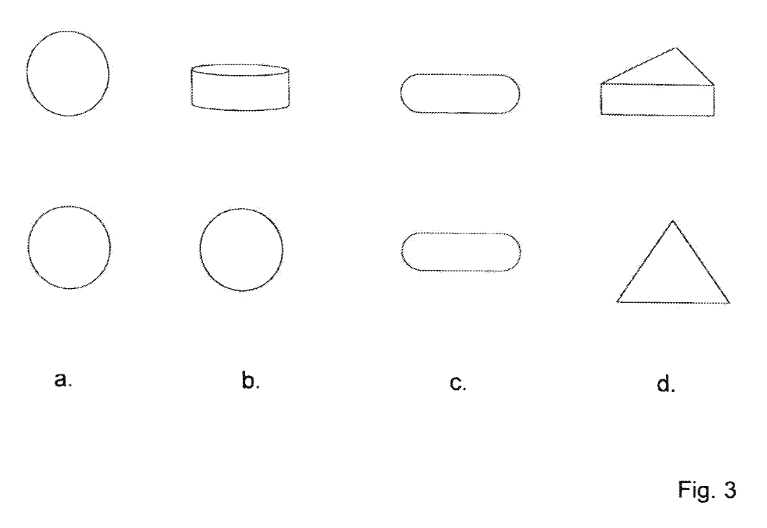

FIG. 3 shows, by way of an example, four different product shapes, in side or partial perspective view in the upper line, and in plan view in the lower line. FIG. 3a shows a spherical preparation, FIG. 3b a circular or cylindrical one, FIG. 3c an elongate (cigar-shaped) one, and FIG. 3d a triangular one. Thus, for instance, the cylindrical shape may indicate an ingestion time before the meal, the elongate shape an ingestion time during the meal, and the triangular shape an ingestion time after the meal.

If the ingestion time with regard to a meal is immaterial, it is possible to use, for example, the spherical shape. In this way, the patient can easily be informed as to which preparations he is supposed to take before, during and after eating.

Alternatively or in addition, it is also possible to provide colour coding (not represented in the drawings) of the ingestion times, for example yellow tablets before the meal, green ones during it, blue afterwards and red if the ingestion time is immaterial.

Instead of the ingestion time with reference to a meal, it is also possible, within the scope of the invention, to encode other product information by means of shape and/or colour. For example, the ingestion time with reference to a meal may be indicated by the shape, and some other piece of information specific to the preparation, by the colour.

The packaged product combination according to the invention and the method according to the invention thus assist in medication of the patient that meets the requirements, so that said patient is in a position to look after himself for longer and is not dependent upon in-patient care.

1. Packaged product combination comprising a number of different medicaments of different shape and/or colour, wherein the shape and/or colour of the medicaments give(s) information regarding the use of the particular medicament.

2. Packaged product combination according to claim 1, wherein the piece of information regarding use is a recommended ingestion time with reference to a meal.

3. Packaged product combination according to claim 1, consisting of a blister pack having a number of receiving compartments, which are sealed by a film in each case, for receiving a number of the medicaments, which receiving compartments are each assigned to a specific time of use of the medicament.

4. Packaged product combination according to claim 3, wherein the receiving compartments of the blister pack are arranged in the form of a matrix, with a number of lines for days of use and columns for times of use during the day.

5. Packaged product combination according to claim 4, wherein the prescribed period is one week, and the blister pack is designed as a “week” blister pack for a week's requirements.

6. Packaged product combination according to claim 1, having a cover, which is formed onto the blister pack, preferably in a foldable manner, for covering the film, and with lettering faces for printing on information regarding use.

7. Packaged product combination according to claim 4, having sections with perforations which allow the severing of individual lines of the matrix-shaped blister pack.

8. Packaged product combination according to claim 1, which is designed as a personalised product combination for packaging an individually prescribed combination of medicaments for a specific person for a prescribed period.

9. Packaged product combination according to claim 1, wherein said product combination comprises products such as medicaments, vitamin preparations, dietary supplements, etc.

10. Method of making up and packaging a product combination consisting of a number of different medicaments of different shape and/or colour, wherein the shape and/or colour of the medicaments themselves is/are so designed that it/they indicate(s) a piece of information regarding the use of the particular medicament.

11. Method according to claim 10, wherein the piece of information regarding use is a recommended ingestion time with reference to a meal.

12. Method according to claim 10, wherein the medicaments for a prescribed period of use are packaged in a number of receiving compartments of a blister pack, which are sealed by a film in each case, which receiving compartments are each assigned to a specific time of use within the prescribed period.

13. Method according to claim 12, wherein the receiving compartments of the blister pack are arranged in the form of a matrix, with a number of lines for days of use and columns for times of use during the day, into which receiving compartments the products are filled in a suitably organised manner.

14. Method according to claim 13, wherein the prescribed period is one week.

15. Method according to claim 10, wherein the product combination is an individually prescribed combination of medicaments for a specific person for a prescribed period.

16. Method according to claim 10, wherein the product combination comprises products such as medicaments, vitamin preparations, dietary supplements, etc.
